(19) United States
(12) Patent Application Publication
(10) Pub. No.: US 2016/0155192 A1
(43) Pub. Date: Jun. 2, 2016

(54) Method and Apparatus for Implementing Member Purchase Program

(71) Applicant: Clear Choice Holdings, LLC, Centennial, CO (US)

(72) Inventor: Matthew Cochran, Castle Rock, CO (US)

(21) Appl. No.: 14/946,335

(22) Filed: Nov. 19, 2015

Related U.S. Application Data
(60) Provisional application No. 62/086,548, filed on Dec. 2, 2014.

(51) Int. Cl. G06Q 40/02

(52) U.S. Cl. CPC G06Q 40/025

(57) ABSTRACT

Novel tools and techniques are provided for implementing purchase programs for members of a financial institution based on member relationship and history with the financial institution (e.g., a credit union or the like).

### CROSS REFERENCE TO RELATED APPLICATIONS

This application claims priority to U.S. Patent Application Ser. No. 62/086,548 (the “'548 Application”), filed Dec. 2, 2014 by Matthew Cochran and titled, “Method and Apparatus for Implementing Member Purchase Program” (attorney docket number 0624.02PR), which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to a device, system, and method for implementing purchase programs, and, more particularly, to a device, system, and method for implementing purchase programs for members of a financial institution based on member relationship and history with the financial institution.

### BACKGROUND

Currently, when a user applies for a loan or credit toward purchase of a product or service, determination of whether to approve the application for the loan or credit is based on the credit score and other personal information about the user. Such determinations are not based on the user's membership or membership history with a financial institution (e.g., credit union or the like). So, even if the user has a good history and good financial relationship (i.e., credit history, etc.) with the financial institution, the user is still limited in terms of loan or credit applications by his or her overall credit history.

With 76% of Americans living paycheck-to-paycheck, with 28% of Americans having no emergency savings, and with nearly 50% of Americans having less than $500 in savings, current credit or loan approval policies and processes severely limit financial options for a significant number of Americans. Such limitations also prevent credit unions and other financial institutions from fully serving their members or customers.

Hence, there is a need for more robust and scalable solutions for providing members of a financial institution (e.g., a credit union or the like) to purchase products and services and/or to obtain loans, credits, and/or financing based on membership and deposit history with the financial institution rather than personal credit ratings.

### BRIEF SUMMARY

Various embodiments provide techniques for implementing purchase programs for members of a financial institution based on member relationship and history with the financial institution.

In some embodiments, a user (who is a member of a financial institution, such as a credit union or the like) might log into his or her account with the financial institution. From the account (such as a web-based account), the user might access a main page that provides access to shopping portals or websites. When the user desires to purchase a product or service, a server might determine whether the user is eligible to be part of a member purchase program, which leverages the collective membership of the financial institution to back the financing for these purchases. The server might determine eligibility of the user based on the user's account history with the financial institution (i.e., the user's financial interactions with the financial institution, including, without limitation, length of time as member/customer of the financial institution, credit requests, timeliness in repayments, any defaults in payment, any missed payments, etc.).

The tools provided by various embodiments include, without limitation, methods, systems, and/or software products. Merely by way of example, a method might comprise one or more procedures, any or all of which might be executed by a computer system. Correspondingly, an embodiment might provide a computer system configured with instructions to perform one or more procedures in accordance with methods provided by various other embodiments. Similarly, a computer program might comprise a set of instructions that are executable by a computer system, or by a processor located in the computer system, to perform such operations. In many cases, such software programs are encoded on physical, tangible, and/or non-transitory computer readable media. Such computer readable media might include, to name but a few examples, optical media, magnetic media, and the like.

In an aspect, an apparatus might comprise one or more processors and a non-transitory computer readable medium in communication with the one or more processors. The computer readable medium might have stored thereon software comprising a set of instructions that, when executed by the one or more processors, causes the apparatus to perform one or more operations. The set of instructions might comprise instructions for receiving a first set of inputs from a user, the first set of inputs comprising a request to purchase at least one of one or more products or one or more services, instructions for prompting the user for user information, instructions for receiving a first set of user information from the user, and instructions for determining whether the user is an authenticated user based on analysis of the first set of user information from the user. The set of instructions might further comprise instructions for determining whether the user is qualified for purchase financing based on user membership relationship and financial management with a financial institution. The set of instructions might also comprise, instructions for, based on a determination that the user is qualified for purchase financing based on user membership relationship with a financial institution, sending a notification to a lending agent authorizing financing of the at least one of one or more products or one or more services. The set of instructions might further comprise instructions for, based on the determination that the user is qualified for purchase financing based on user membership relationship with a financial institution, sending a purchase order for the at least one of one or more products or one or more services to a fulfillment agent for shipping the at least one of one or more products or one or more services to the user.

In some embodiments, the determination that the user is qualified for purchase financing based on user membership relationship with a financial institution might comprise receiving, from the user, a password that is generated and sent to the user in response to a periodic determination by the financial institution that the user is qualified for purchase financing. The periodic determination might comprise generating a weekly list of eligible members based on daily purchases reports of each member. According to some embodiments, the financial institution might be a credit union, and the user might be a member of the credit union. In some instances, the user membership relationship with a financial institution might comprise at least one of membership history that the user has with the financial institution and/or financial interaction history that the user has with the financial institution.

In another aspect, an apparatus might comprise one or more processors and a non-transitory computer readable medium in communication with the one or more processors. The computer readable medium might have stored thereon software comprising a set of instructions that, when executed by the one or more processors, causes the apparatus to perform one or more operations. The set of instructions might comprise instructions for receiving a first set of inputs from a user, the first set of inputs comprising a request to purchase at least one of one or more products or one or more services. The set of instructions might also comprise, instructions for, based on a determination that the user is qualified for purchase financing based on user membership relationship with a financial institution, sending a notification to a lending agent authorizing financing of the at least one of one or more products or one or more services. The set of instructions might further comprise instructions for, based on the determination that the user is qualified for purchase financing based on user membership relationship with a financial institution, sending a purchase order for the at least one of one or more products or one or more services to a fulfillment agent for shipping the at least one of one or more products or one or more services to the user.

In yet another aspect, a method might comprise receiving, with a first computer, a first set of inputs from a user, the first set of inputs comprising a request to purchase at least one of one or more products or one or more services. The method might further comprise determining, with the first computer, eligibility of the user to receive financing for the at least one of one or more products or one or more services, based on membership history of the user with a financial institution.

In some embodiments, the method might also comprise, based on a determination that the user is qualified to receive financing for the at least one of one or more products or one or more services based on membership history of the user with a financial institution, sending a notification to a lending agent authorizing financing of the at least one of one or more products or one or more services. In some cases, the might further comprise, based on a determination that the user is qualified to receive financing for the at least one of one or more products or one or more services based on membership history of the user with a financial institution, sending a purchase order for the at least one of one or more products or one or more services to a fulfillment agent for shipping the at least one of one or more products or one or more services to the user.

In some cases, the financial institution might be a credit union, and the user might be a member of the credit union. In some instances, the user membership relationship with a financial institution might comprise at least one of membership history that the user has with the financial institution and/or financial interaction history that the user has with the financial institution.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a general schematic diagram illustrating a system for implementing purchase programs for members of a financial institution based on member relationship and history with the financial institution, in accordance with various embodiments.

FIG. 2A is a general schematic diagram illustrating a method for implementing purchase programs for members of a financial institution based on member relationship and history with the financial institution, in accordance with various embodiments.

FIG. 2B is a general schematic diagram illustrating another method for implementing purchase programs for members of a financial institution based on member relationship and history with the financial institution, in accordance with various embodiments.

FIG. 3 is a flow diagram illustrating a method for implementing purchase programs for members of a financial institution based on member relationship and history with the financial institution, in accordance with various embodiments.

FIG. 4 is a block diagram illustrating an exemplary computer architecture, in accordance with various embodiments.

FIG. 5 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments provide techniques for implementing purchase programs for members of a financial institution based on member relationship and history with the financial institution (e.g., a credit union or the like).

In some embodiments, a user (who is a member of a financial institution, such as a credit union or the like) might log into his or her account with the financial institution. From the account (such as a web-based account), the user might access a main page that provides access to shopping portals or websites. When the user desires to purchase a product or service, a server might determine whether the user is eligible to be part of a member purchase program, which leverages the collective membership of the financial institution to back the financing for these purchases. The server might determine eligibility of the user based on the user's history with the financial institution (i.e., the user's financial interactions with the financial institution, including, without limitation, length of time as member/customer of the financial institution, credit requests, timeliness in repayments, any defaults in payment, any missed payments, etc.).

These and other aspects of the member purchase program are described in further detail below.

Overview

In various embodiments, a web application might have the following non-limiting structure and core functionality.

Structure:

In some embodiments, a web application might be based on a web framework (e.g., the Ruby on Rails web framework running on Ruby v2.1.2, or the like). The application (e.g., Rails application or the like) might utilize a deployment platform (e.g., the Heroku deployment platform or the like) and might run under a web server (e.g., the Passenger web server or the like).

In addition to the core application (e.g., Rails application), background job processing might be provided by, e.g., the Sidekiq project or the like.

The application, according to some embodiments, might be based on one or more of the following technologies: PostgreSQL database for persistent data storage; ElasticSearch search engine for search functionality; Redis key-value store for caching and background job management; Mandrill transactional email processing; Rollbar error reporting service; NewRelic server/application monitoring service; and/or the like.

The application might be built on the mobile-first, responsive Bootstrap grid system, or the like.

Core Functionality:

The application, in some embodiments, might be built to facilitate approved members of a credit union (or other financial institution) to securely enroll in the service, and then to subsequently make purchases via an online store (which, in some cases, might be associated with the service). The store might provide members of the credit union (or other financial institution) with the ability to track their purchases, to edit some of their personal information, to create product reviews, to manage a product wish list, and/or the like.

The application might also track how much a customer is approved to borrow from his or her credit union (or other financial institution) via a “wallet” feature. This wallet reflects the current amount of money that the customer can spend via a loan or the like. The wallet's balance is deducted when the customer makes purchases and is credited when an ACH payment is made.

A. Enrollment Process

Data Import

The service provider is provided a data dump from a credit union (or other financial institution), which provides the following pieces of information about each potential customer: the last 4 digits of his or her social security number; the last 4 digits of his or her primary banking account number; an access code (which does not need to be unique); the date of the customer's last ACH paycheck deposit; the frequency (in days) of that customer's ACH paycheck deposits; a unique, anonymous identifier that is generated by the payment processor (e.g., Forte, or the like), which allows payments to be scheduled against the customer without knowing his or her financial information; and/or the like.

When the system imports the customer list, a Customer is created in the system with all of the aforementioned data saved.

Customer Enrollment

The customer, in some cases, might be provided his or her access code by his or her credit union (or other financial institution). The customer might then go to that credit union's (or other financial institution's) landing page (e.g., “my_credit_union.goclearchoice.com”; or the like) and will be directed to an enrollment area for the service.

The enrollment process might ask for the customer's two “last 4-digit” pieces of information and his or her access code. A lookup might then be performed on these three pieces of information to find the associated customer. If the customer is found, an Enrollment and a User are created in the system. The Enrollment tracks the enrollment process itself and the User tracks the actual login account, purchases, etc. of the customer in the system.

After an Enrollment and User have been created, the user might be asked to provide his or her first name, last name, and e-mail address. A confirmation e-mail might be sent to the user with a link. Once the user clicks on this link, the user will be asked to provide a password for this or her account. The user is then taken to the store.

B. Store

Data Import

The store, in some instances, might be populated with items via transformed data feeds originating from various vendors. Multiple import strategies might be implemented to correspond with the data format from an individual vendor. The import strategies might normalize the data dumps into a format that is fit for the store while also creating the necessary taxonomy, brands, collections, and/or the like for products being imported.

Shopping

According to some embodiments, products might be stored in a series of nested taxonomies that a user can browse.

The underlying source code might be built to be able to handle a faceted type of search and/or filtration.

The search engine (e.g., the ElasticSearch search engine, or the like) might provide a full text search functionality that might allow customers to receive accurate results to their search queries based upon products that are available in the store. The search might be a learning search, such that it will accommodate for misspellings and results that are more popular for a given search term (e.g., customer do not need to re-search to find what they are looking for).

Purchasing

Purchasing might be accomplished via a normal e-commerce workflow, with the exception of the specification of a “repayment period.”

For example, when a customer is on an individual product page, he or she might be given the option of selecting a 6, 12, or 18 month repayment period. He or she can then add that product to his or her shopping cart where the selected repayment period has been preserved.

The shopping cart itself might be persisted down to the database level so that customer can have a shopping cart that is available across different and multiple browsers and devices (i.e., available anywhere he or she is logged in).

The purchasing process, in some cases, may be relatively straight forward—that is, a customer specifies his or her shipping address, reviews his or her order, agrees to the loan disclosures (e.g., via DocuSign or the like), and/or the like. When he or she is ready to submit the order, the system checks the order's total amount (with taxes and shipping included) against the customer's wallet balance. If the total amount is less than the wallet valance, the order is placed. On the other hand, if the total amount exceeds the wallet balance, then the customer is provided with the opportunity to pay for the difference via an “out of pocket” payment method. This additional payment might be collected via the payment processor's (e.g., Forte's or the like's) secure web pay product via an in-browser web form that is posted directly to the payment processor's (e.g., Forte's) servers.

The order's monthly payment might be calculated as the sum of each monthly payment for each item in the order, plus the sum of the taxes and shipping amounts, divided by the maximum monthly payment term. For example, for 2 items at $50 per month over 6 months and 1 item at $100 per month over 12 months, plus $12 in taxes and $24 in shipping charges, the order would be $200 per month for the items, plus $3 per month for taxes and shipping (i.e., $36 total divided by max(6 and 12) equals $3).

Order Processing

When an order is received, the following actions might occur: the order might be set to the “accepted” state; an e-mail confirmation might be scheduled to be sent to the customer; an order confirmation might be scheduled to be sent to the customer service; an automated ACH withdrawal might be scheduled with the payment processor (e.g., Forte, or the like) for the monthly payment amount and might be set to coincide with a paycheck deposit; an ACH payment might be scheduled with the payment processor (e.g., Forte, or the like) for the balance of the order to be sent to the various vendors so that products can be released for shipping; shipping might be set up; and/or the like.

C. Payments

According to some embodiments, a payment processor (e.g., Forte, or the like) might post the results of automated ACH payments back to the application. The application might parse this incoming data to determine which customer it applies to, might look at the status of the transaction (either success or failure), and might record the payment. The customer's wallet would automatically be updated as part of the payment recording process.

D. Reviews

The reviews functionality, in some cases, allows a customer to write a review of one or more products, and the review will be made visible on each such product's own page. The review functionality, in some embodiments, provides the customer with the ability to rank a product on a 5-star scale in half-star increments, or the like. The product's total rating is the average of all star ratings provided by customers.

E. Wishlist

Customers, in some instances, can add one or more products to their respective wish lists to be “saved for later.” The wish list is viewable from the customer's account dashboard. The wish list provides the customer an ability to quickly add an item to his or her shopping cart or to remove the item from the wish list.

F. Dashboard

In some embodiments, the customer's dashboard might provide the customer with the ability to see his or her payment history, order history, or the like, to edit personal information (including, but not limited to, name, address, e-mail, etc.), to view or edit his or her wish list, to add, view/edit, or delete his or her reviews, and/or the like. The dashboard might also provide some quick links for the customer (including, without limitation, quick links to report a payment problem, quick links to view recent orders, and/or the like).

G. Miscellaneous Pages

A variety of miscellaneous pages might be implemented on the website. For example, FAQs, Terms of Service, and/or the like are among such pages with static content. A general “contact us” page might also be implemented.

### Specific Exemplary Embodiments

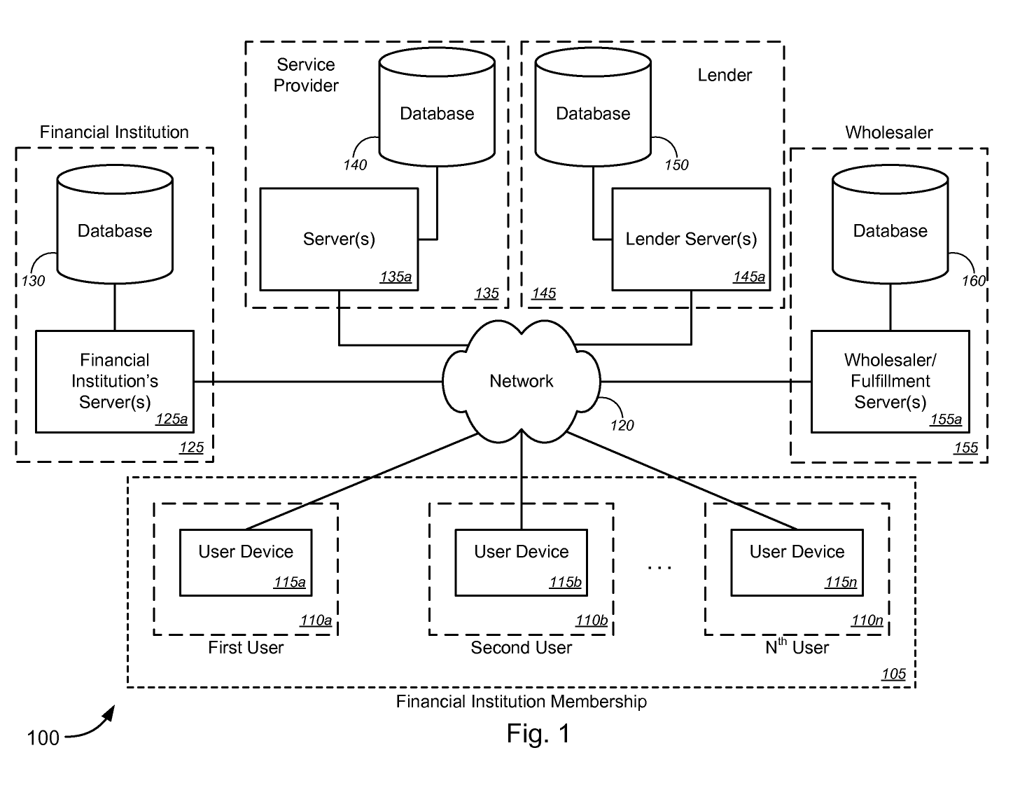

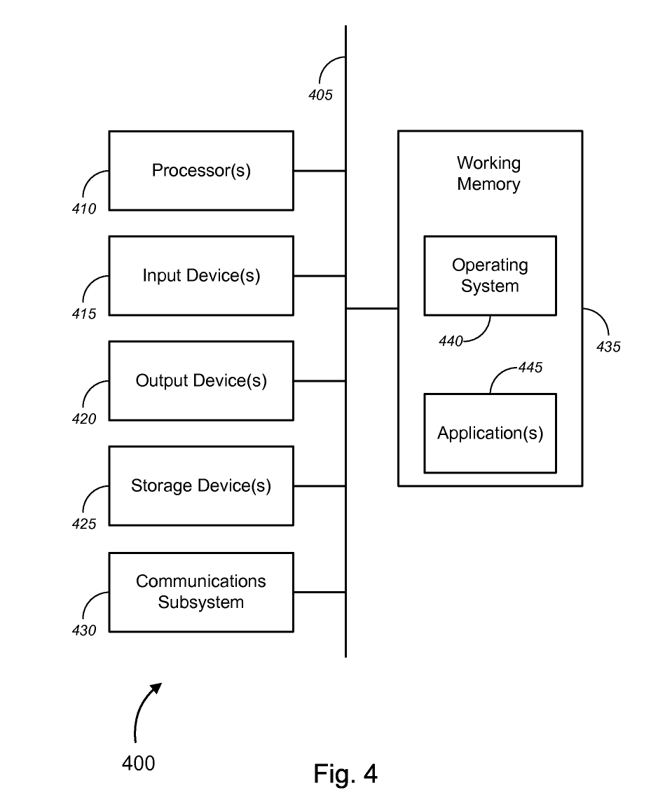

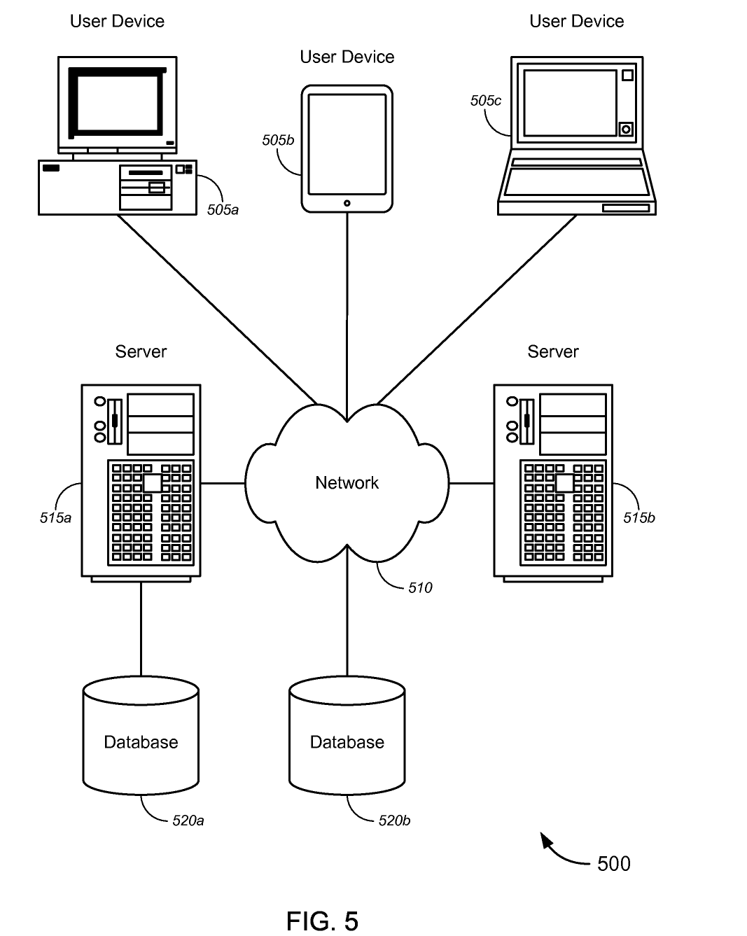

We now turn to the embodiments as illustrated by the drawings. FIGS. 1-5 illustrate some of the features of the method, system, and apparatus for implementing purchase programs for members of a financial institution based on member relationship and history with the financial institution, as referred to above. FIGS. 1-3 illustrate some of the specific (although non-limiting) exemplary features of the method, system, and apparatus for implementing purchase programs for members of a financial institution based on member relationship and history with the financial institution, while FIGS. 4 and 5 illustrate exemplary system and hardware implementation. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 is a general schematic diagram illustrating a system 100 for implementing purchase programs for members of a financial institution based on member relationship and history with the financial institution, in accordance with various embodiments. In FIG. 1, system 100 might comprise financial institution membership 105, which might comprise a first user 110a, a second user 110b, through N^{th} user 110n (collectively, “user 110” or “member 110”). Each user 110 might have an associated user device(s) 115 (i.e., user device 115a associated with the first user 110a, user device 115b associated with the second user 110b, user device 115n associated with the N^{th} user 110n, and so on). Each user device 115 might be any suitable user device including, but not limited to, a gaming console, a digital video recording and playback device (“DVR”), a set-top or set-back box (“STB”), one or more television sets (“TVs”), a desktop computer, a laptop computer, and/or one or more mobile user devices. The one or more TVs might include any one or combination of a high-definition (“HD”) television, an Internet Protocol television (“IPTV”), and a cable television, or the like, where one or both of HDTV and IPTV may be interactive TVs. The one or more mobile user devices might comprise one or more tablet computers, one or more smart phones, one or more mobile phones, or one or more portable gaming devices, and/or the like.

The user 110 might sign up with or log into, via user device 115 over network 120, a website or other portal hosted by a server(s) 125a associated with the financial institution 125. The user's log-in information (including, but not limited to, username and password, etc.) and personal information (including, without limitation, one or more of, full name of the user, address of the user, accounts associated with the user, social security number (or last four digits thereof), personal identification number(s) (“PIN(s)”), history of financial interactions between the user and the financial institution, and/or the like) may be stored in database 130, which is communicatively coupled with the server(s) 125a and might be associated with the financial institution 125. In some cases, the financial institution might be a credit union, and the user might be a member of the credit union. In alternative cases, the financial institution might be a bank, a trust company, a loan company, etc.

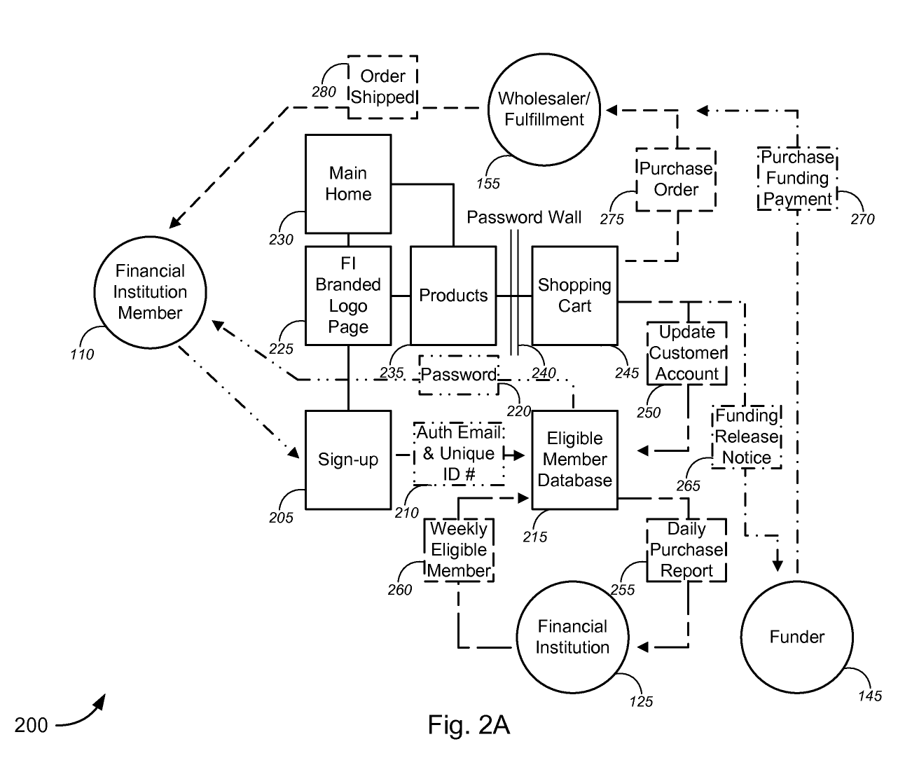

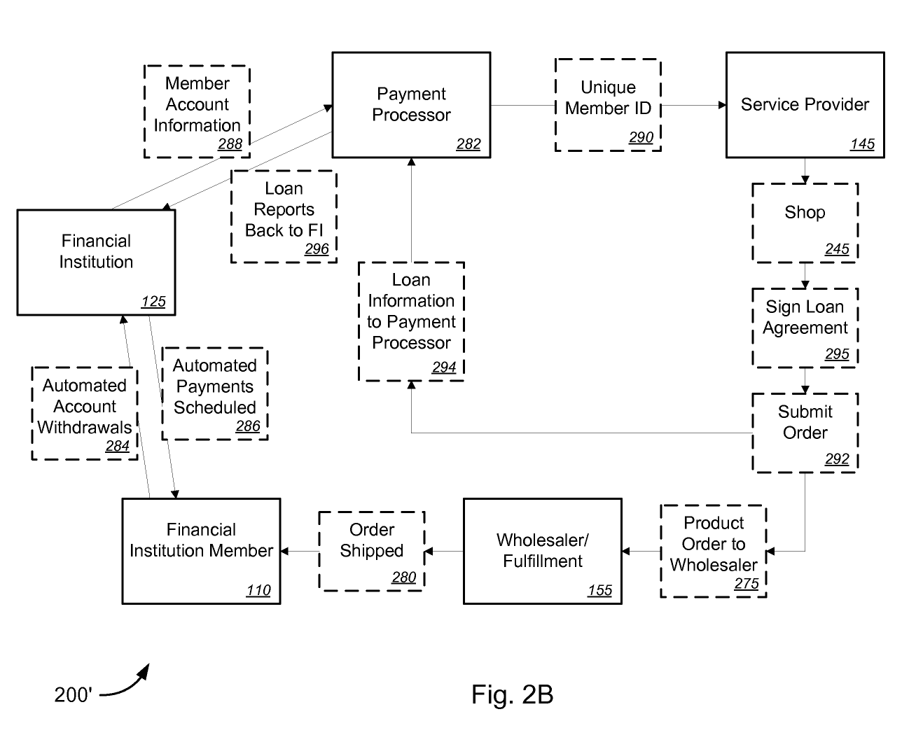

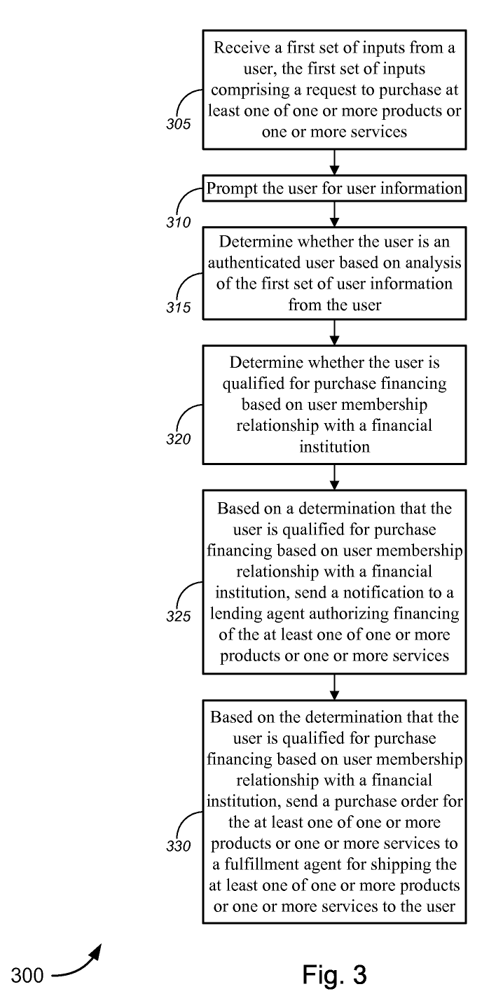

In some embodiments, system 100 might further comprise one or more servers 135a associated with a service provider 135 that might provide the financial institution with a system for implementing member purchase programs for the members/users/customers of the financial institution. For example, the service provider server(s) 135a might perform the processes in the method described in further detail herein (particularly in FIGS. 2 and 3). In some cases, the service provider server(s) 135a might perform such processes in the background, such that, from the perspective of the user or member 110 of the financial institution 125, the financial institution server(s) 125(a) might be performing these processes. Database 140, which might be communicatively coupled with server(s) 135a and associated with service provider 135, might store information about one or more users 110, such information including, but not limited to, the last 4 digits of the user's social security number, the last 4 digits of the user's primary banking account number, an access code for the user (which does not need to be unique), the date of the user's last automated clearing house (“ACH”) paycheck deposit, a unique, anonymous identifier that is generated by a payment processor, which allows payments to be scheduled against the user without knowing the user's financial information.

System 100 might further comprise lender server(s) 145a associated with a lender 145, including, but not limited to, another financial institution, the same financial institution, a loan company, etc. Database 150, which might be communicatively coupled with server(s) 145a and associated with lender 145, might store information associated with one or more of the user, the financing request, a decision pertaining to the financing request, repayment options selected by the user, and/or the like.

System 100 might also comprise server(s) 155a associated with a wholesaler or fulfillment company 155, which might be a company that sells or distributes products and/or performs services. Database 160, which might be communicatively coupled with server(s) 155a and associated with wholesaler/fulfillment company 155, might store information associated with one or more of the user (e.g., shipping information, etc.), purchase orders provided for the benefit of the user (e.g., from service provider 135 and/or financial institution 125), financing information from the lender 145 in association with purchase orders provided for the benefit of the user, and/or the like.

In operation, a user 110 might log into or register on a website hosted by the financial institution's server(s) 125a, which might be powered by server(s) 135a to offer the user 110 an opportunity to participant in a member purchase program. The server(s) 135a (in some cases, through server(s) 125a) might obtain information regarding the user, information regarding the user's history of ACH payments, and/or information regarding the user's history with the financial institution 125, and, based on such information, can determine whether the user is eligible to be part of the member purchase program and/or might determine how much credit the user is eligible to have. In such cases, the server(s) 135a and its functionalities might be transparent to the user (i.e., the user is not aware of the server(s) 135a and/or the service provider 135, but believes that everything is being handled through and by the financial institution 125 with which the user is a member or customer). In some embodiments, the financial institution's server(s) 125a might perform one or more of obtaining/retrieving the information (i.e., information regarding the user, information regarding the user's history of ACH payments, and/or information regarding the user's history with the financial institution 125, or the like), determining whether the user is eligible to be part of the member purchase program, and/or determining how much credit the user is eligible to have, or the like. When the user is deemed eligible, the server(s) 135a might generate a unique, anonymous identifier that allows payments to be scheduled against the customer without knowing their financial information. In some cases, a new unique, anonymous identifier might be generated at periodic cycles (e.g., every day, every week, every month, etc.) in response to periodic review of the user's remaining credit. For example, the user might be deemed eligible and might be provided with a credit of $10,000. If the user spends $5,000, the system might determine or track how much of the $5,000 has been paid off over a certain period. If most or all of it has been paid off, the periodic review might be positive, leading to generation of a (new) unique, anonymous identifier.

Through the server(s) 135a (in some cases, through server(s) 125a), the user might be given access to a user interface (e.g., website) that allows the user to shop for products and/or services. After selecting one or more products and/or one or more services for purchase, the user might be given the option to use the member purchase program, if deemed eligible (at the above-mentioned phases). In some cases, when deemed eligible, the user might be provided with a unique, anonymous identifier (as described above). The user might use this unique, anonymous identifier to initiate payments under the member purchase program through the server(s) 135a. Under this program, the lender server(s) 145a might receive a notification from the server(s) 135a. The notification might authorize the lender 145 to provide financing to the user 110, to be paid off over a period (e.g., 6 months, 12 months, 18 months, etc.) that is selected by the user 110. In some cases, the financing might be without interest, while in other cases the financing might be at a low interest rate (i.e., lower than standard bank loan interest rates). The lender 145 (in some cases, through server(s) 145a) might provide payment information to wholesaler/fulfillment company 155 (through server(s) 155a over network 120). Wholesaler/fulfillment company 115 might concurrently or sequentially receive a purchase order indicating the one or more products and/or one or more services selected for purchase, as well as information about the user (including, without limitation, name and shipping address), and might initiate the shipping process of the purchased one or more products and/or one or more services.

These and other operations of system 100 are described in terms of similar embodiments in the Overview above and with respect to FIGS. 2-3.

FIG. 2A is a general schematic diagram illustrating a method 200 for implementing purchase programs for members of a financial institution based on member relationship and history with the financial institution, in accordance with various embodiments. FIG. 2B is a general schematic diagram illustrating another method 200′ for implementing purchase programs for members of a financial institution based on member relationship and history with the financial institution, in accordance with various embodiments.

While the techniques and procedures of FIGS. 2A and 2B (collectively, “FIG. 2”) are depicted and/or described in a certain order for purposes of illustration, it should be appreciated that certain procedures may be reordered and/or omitted within the scope of various embodiments. Moreover, while the method illustrated by FIG. 2 can be implemented by (and, in some cases, are described below with respect to) the systems 100, 400, and/or 500 of FIGS. 1, 4, and/or 5, respectively (or components thereof), these methods may also be implemented using any suitable hardware implementation. Similarly, while each of the system 100 (and/or components thereof) of FIG. 1, the system 400 (and/or components thereof) of FIG. 4, and/or the system 500 (and/or components thereof) of FIG. 5 can operate according to the method illustrated by FIG. 2 (e.g., by executing instructions embodied on a computer readable medium), the systems 100, 400, and/or 500 can also operate according to other modes of operation and/or perform other suitable procedures.

In FIG. 2A, method 200 might comprise a credit union member 110 signing up for the member purchase program (block 205). At block 210, authentication e-mail address and/or unique identification (“ID”) number is created, and (at block 215) is stored in an eligible member database. The eligible member database might provide a password (block 220) to the member 105. In some cases, the password might correspond to the unique, anonymous identifier described above.

After signing up (at block 205), the member 110 might be taken to a landing page associated with the credit union (or a landing page that is otherwise branded by the credit union) (block 225). In some cases, once signed up, the member 110 can directly access the landing page, and might access his or her account by logging into the credit union's website. Once, logged in, the member 110 might be led to a main home page (block 230). Through either the landing page or the main home page, the member 110 might access a shopping user interface, which might allow the member 110 to search for or browse items or services for purchase (block 235). In some embodiments, to put selected product(s) and/or service(s) in a shopping cart, the member 110 might go through a password wall (block 240), i.e., by providing the password (that was sent to the user at block 220). In some cases, the member 110 might be able to freely place selected product(s) and/or service(s) in the shopping cart, but might encounter the password wall when attempting to proceed to checkout. After filling the shopping cart and initiating checkout (block 245), the customer account information (e.g., purchase amount, or the like) might be updated in the eligible member database (block 250).

Regarding the eligible member database, the server(s) 135a associated with the service provider 135 of FIG. 1 or the like might provide daily purchase reports for the member 110 to the credit union 125 (block 255). The credit union 125 might then generate a list (e.g., weekly list or the like) of eligible members (block 260). If the member 110 is diligent in paying off the credit amount/balance or substantial portions of the credit amount/balance, the credit union 125 (or server(s) 125a) might leave the member 110 on the list of eligible members. On the other hand, if the member 110 fails to pay off the credit amount/balance over a certain number of times (e.g., 1 time, 2 times, 3 times, etc.), the credit union 125 (or server(s) 125a) might remove the member 110 from the list of eligible members. Back at block 215, the eligible member database might send out a different password to the member 110 (block 220), each time the list of eligible members returns from the credit union listing the member 110 as an eligible member.

Concurrent with or sequential to updating the customer account information (at block 250), a funding release notice might be sent to funder/lender 145 (block 265), which might forward purchase funding payment to wholesale/fulfillment company 155 (block 270). Meanwhile, a purchase order indicating the selected product(s) and/or service(s) as well as information about the user (e.g., name and shipping address, or the like) might be sent to the wholesale/fulfillment company 155 (block 275), which might ship the order to the member 110 (block 280).

With reference to FIG. 2B, method 200′ might comprise a member 110 of a financial institution 125 (e.g., a credit union, bank, or the like) arranging automated account withdrawals (block 284) with the financial institution 125), while scheduling automated payments (block 286) with the financial institution 125. The financial institution 125 might send member account information (including account history and account information, or the like, of member 110) to a payment processor 282 (e.g., Forte, or the like). The payment processor 282 might hold account data, might store purchasing information, might store credit card information if provided by member 110, and might provide a unique identifier (e.g., a token, or the like) to the application and/or the service provider 145 (e.g., Funder 145 in FIG. 2A, service provider 135 in FIG. 1, or Lender 145 in FIG. 1, or the like). In some cases, the payment processor 282 might be an ACH payment processor. The payment processor 282, in some embodiments, might send the unique member identifier (which might also include loan amount limits, unique identification number, financial institution account information, or the like) of the member 110 to the service provider 145.

Once determined to be qualified for purchase financing by the service provider 145 based on membership relationship and financial management with the financial institution 125, member 110 might be provided with options to shop for one or more products (block 245). After selecting desired products (to be placed in the “shopping cart”) and choosing to checkout, the service provider 145 might send a loan agreement for the member 110 to sign (e.g., using DocuSign, or the like; block 295), provided that the total of the items in the shopping cart plus applicable taxes and shipping costs are less than the loan amount limits. If the total of the items (plus applicable taxes and shipping costs) exceeds the loan amount limits, the member 110 might be given the option to “pay out of pocket” (not shown). After signing the loan agreement (and arranging to “pay out of pocket,” if necessary), the order is submitted (block 292). At block 294, the loan information might be sent to the payment processor 282, which in turn sends loan reports back to the financial institution 125 (block 296). Meanwhile, the product order is sent to the wholesaler 155 (block 275), which ships the order to the member 110 (block 280). The embodiment of FIG. 2B might otherwise be similar to that of FIG. 2A.

We now turn to FIG. 3, which is a flow diagram illustrating a method 300 for implementing purchase programs for members of a financial institution based on member relationship and history with the financial institution, in accordance with various embodiments. While the techniques and procedures of FIG. 3 are depicted and/or described in a certain order for purposes of illustration, it should be appreciated that certain procedures may be reordered and/or omitted within the scope of various embodiments. Moreover, while the method illustrated by FIG. 3 can be implemented by (and, in some cases, are described below with respect to) the systems 100, 400, and/or 500 of FIGS. 1, 4, and/or 5, respectively (or components thereof), these methods may also be implemented using any suitable hardware implementation. Similarly, while each of the system 100 (and/or components thereof) of FIG. 1, the system 400 (and/or components thereof) of FIG. 4, and/or the system 500 (and/or components thereof) of FIG. 5 can operate according to the method illustrated by FIG. 3 (e.g., by executing instructions embodied on a computer readable medium), the systems 100, 400, and/or 500 can also operate according to other modes of operation and/or perform other suitable procedures.

In FIG. 3, method 300 might comprise, at block 305, receiving a first set of inputs from a user, the first set of inputs comprising a request to purchase at least one of one or more products or one or more services. Method might further comprise prompting the user for user information (block 310), receiving a first set of user information from the user, and determining whether the user is an authenticated user based on analysis of the first set of user information received from the user (block 315). At block 320, method 300 might comprise determining whether the user is qualified for purchase financing based on user membership relationship with a financial institution. In some embodiments, determining that the user is qualified for purchase financing based on user membership relationship with a financial institution might comprise receiving, from the user, a password that is generated and sent to the user in response to a periodic determination by the financial institution that the user is qualified for purchase financing. In some cases, the password might correspond to unique, anonymous identifier that is described in detail above. In some instances, periodic determination might comprise generating a weekly (monthly, or quarterly) list of eligible members based on daily purchases reports of each member.

Method 300, at block 325, might comprise, based on a determination that the user is qualified for purchase financing based on user membership relationship with a financial institution, sending a notification to a lending agent authorizing financing of the at least one of one or more products or one or more services. At block 330, based on the determination that the user is qualified for purchase financing based on user membership relationship with a financial institution, sending a purchase order for the at least one of one or more products or one or more services to a fulfillment agent for shipping the at least one of one or more products or one or more services to the user.

In the manner described above, the user or member of a credit union or other financial institution can leverage his or her membership (and history) with the credit union or other financial institution to qualify for loans or credit, without relying on his or her own personal credit score. In some cases, the purchase program (as described above) might offer 0% interest rates on financing of purchases or the like. This system allows the user to build credit by being able to more easily manage repayment of purchases through this program, where the user might be left with little option and stark prospects if only relying on personal credit score (especially if his or her personal credit score is not sufficiently high). The credit union, at the same time, can benefit by serving the user or member, when the member needs it the most.

Although the embodiments of FIGS. 1-3 are described using specific examples, in some cases, the various embodiments are not so limited, and any variation of the embodiments described with respect to FIGS. 1-3 (or equivalents thereof) and the Overview (or equivalents thereof) may be implemented, while remaining within the scope of the invention.

Exemplary System and Hardware Implementation

We now turn to FIG. 4, which is a block diagram illustrating an exemplary computer architecture. FIG. 4 provides a schematic illustration of one embodiment of a computer system 400 that can perform the methods provided by various other embodiments, as described herein, and/or can perform the functions of local computer system 115, or remote computer systems 125a, 135a, 145a, or 155a, or other computer systems as described above. It should be noted that FIG. 4 is meant only to provide a generalized illustration of various components, of which one or more, or none, of each may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405, or may otherwise be in communication, as appropriate. The hardware elements may include one or more processors 410, including without limitation one or more general-purpose processors, or one or more special-purpose processors such as digital signal processing chips, graphics acceleration processors, or the like; one or more input devices 415, which can include without limitation a mouse, a keyboard, or the like; and one or more output devices 420, which can include without limitation a display device, a printer, or the like.

The computer system 400 may further include, or be in communication with, one or more storage devices 425. The one or more storage devices 425 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including without limitation various file systems, database structures, or the like.

The computer system 400 might also include a communications subsystem 430, which can include without limitation a modem, a network card (wireless or wired), an infra-red communication device, a wireless communication device or chipset, or the like. The wireless communication device might include, but is not limited to, a Bluetooth™ device, an 802.11 device, a WiFi device, a WiMax device, a WWAN device, cellular communication facilities, or the like.

The communications subsystem 430 may permit data to be exchanged with a network (such as network 120, to name examples), with other computer systems, with any other devices described herein, or with any combination of network, systems, and devices. According to some embodiments, network 120 might include a local area network (“LAN”), including without limitation a fiber network, an Ethernet network, a Token-RingTm network, and the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol, or any other wireless protocol; or any combination of these or other networks. In many embodiments, the computer system 400 will further comprise a working memory 435, which can include a RAM or ROM device, as described above.

The computer system 400 may also comprise software elements, shown as being currently located within the working memory 435, including an operating system 440, device drivers, executable libraries, or other code. The software elements may include one or more application programs 445, which may comprise computer programs provided by various embodiments, or may be designed to implement methods and/or configure systems provided by other embodiments, as described herein. Merely by way of example, one or more procedures described with respect to the methods discussed above might be implemented as code or instructions executable by a computer or by a processor within a computer. In an aspect, such code or instructions can be used to configure or adapt a general purpose computer, or other device, to perform one or more operations in accordance with the described methods.

A set of these instructions or code might be encoded and/or stored on a non-transitory computer readable storage medium, such as the storage devices 425 described above. In some cases, the storage medium might be incorporated within a computer system, such as the system 400. In other embodiments, the storage medium might be separate from a computer system—that is, a removable medium, such as a compact disc, or the like. In some embodiments, the storage medium might be provided in an installation package, such that the storage medium can be used to program, configure, and/or adapt a general purpose computer with the instructions/code stored thereon. These instructions might take the form of executable code, which is executable by the computer system 400, or might take the form of source or installable code. The source or installable code, upon compilation, installation, or both compilation and installation, on the computer system 400 might take the form of executable code. Compilation or installation might be performed using any of a variety of generally available compilers, installation programs, compression/decompression utilities, or the like.

It will be apparent to those skilled in the art that substantial variations may be made in accordance with specific requirements. For example, customized hardware—such as programmable logic controllers, field-programmable gate arrays, application-specific integrated circuits, or the like—might also be used. In some cases, particular elements might be implemented in hardware, software (including portable software, such as applets, etc.), or both. Further, connection to other computing devices such as network input/output devices may be employed.

As mentioned above, in one aspect, some embodiments may employ a computer system, such as the computer system 400, to perform methods in accordance with various embodiments of the invention. According to a set of embodiments, some or all of the procedures of such methods might be performed by the computer system 400 in response to processor 410 executing one or more sequences of one or more instructions. The one or more instructions might be incorporated into the operating system 440 or other code that may be contained in the working memory 435, such as an application program 445. Such instructions may be read into the working memory 435 from another computer readable medium, such as one or more of the storage devices 425. Merely by way of example, execution of the sequences of instructions contained in the working memory 435 might cause the one or more processors 410 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 400, various computer readable media might be involved in providing instructions or code to the one or more processors 410 for execution, might be used to store and/or carry such instructions/code such as signals, or both. In many implementations, a computer readable medium is a non-transitory, physical, or tangible storage medium. Such a medium may take many forms, including, but not limited to, non-volatile media, volatile media, and transmission media. Non-volatile media includes, for example, optical disks, magnetic disks, or both, such as the storage devices 425. Volatile media includes, without limitation, dynamic memory, such as the working memory 435. In some alternative embodiments, a computer readable medium may take the form of transmission media, which includes, without limitation, coaxial cables, copper wire and fiber optics, including the wires that comprise the bus 405, as well as the various components of the communication subsystem 430 (and/or the media by which the communications subsystem 430 provides communication with other devices). In an alternative set of embodiments, transmission media can also take the form of waves (including without limitation radio, acoustic and/or light waves, such as those generated during radio-wave and infra-red data communications).

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium with patterns of holes; a RAM, a PROM, an EPROM, a FLASH-EPROM, or any other memory chip or cartridge; a carrier wave; or any other medium from which a computer can read instructions or code.

As noted above, a set of embodiments comprises methods and systems for implementing purchase programs for members of a financial institution based on member relationship and history with the financial institution. FIG. 5 illustrates a schematic diagram of a system 500 that can be used in accordance with one set of embodiments. The system 500 can include one or more user computers or user devices 505. A user computer or user device 505 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer or user device 505 can also have any of a variety of applications, including one or more applications configured to perform methods provided by various embodiments (as described above, for example), as well as one or more office applications, database client and/or server applications, and/or web browser applications. Alternatively, a user computer or user device 505 can be any other electronic device, such as a thin-client computer, Internet-enabled mobile telephone, and/or personal digital assistant, capable of communicating via a network (e.g., the network 510 described below) and/or of displaying and navigating web pages or other types of electronic documents. Although the exemplary system 500 is shown with three user computers or user devices 505, any number of user computers or user devices can be supported.

Certain embodiments operate in a networked environment, which can include a network 510. The network 510 can be any type of network familiar to those skilled in the art that can support data communications using any of a variety of commercially-available (and/or free or proprietary) protocols, including without limitation TCP/IP, SNA™, IPX™, AppleTalk™, and the like. Merely by way of example, the network 510 can include a local area network (“LAN”), including without limitation a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 515. Each of the server computers 515 may be configured with an operating system, including, without limitation, any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 might be a data server, as described above. The data server might include (or be in communication with) a web server, which can be used, merely by way of example, to process requests for web pages or other electronic documents from user computers 505. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 505 to perform methods of the invention.

The server computers 515, in some embodiments, might include one or more application servers, which can be configured with one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, Selenium, or TCL, as well as combinations of any programming and/or scripting languages. The application server(s) can also include database servers, including, without limitation, those commercially available from Oracle™, Microsoft™, Sybase™, IBM™ and the like, which can process requests from clients (including, depending on the configuration, dedicated database clients, API clients, web browsers, etc.) running on a user computer or user device 505 and/or another server 515. In some embodiments, an application server can perform one or more of the processes for implementing automated cloud expansion and ordering, or the like, as described in detail above. Data provided by an application server may be formatted as one or more web pages (comprising HTML, JavaScript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement various disclosed methods, incorporated by an application running on a user computer 505 and/or another server 515. Alternatively, as those skilled in the art will appreciate, a file server can include all necessary files, allowing such an application to be invoked remotely by a user computer or user device 505 and/or server 515.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer or user device 505). Alternatively, a database 520b can be remote from any or all of the computers 505, 515, so long as it can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. An apparatus, comprising:
one or more processors; and
a non-transitory computer readable medium in communication with the one or more processors, the computer readable medium having stored thereon software comprising a set of instructions that, when executed by the one or more processors, causes the apparatus to perform one or more operations, the set of instructions comprising:
instructions for receiving a first set of inputs from a user, the first set of inputs comprising a request to purchase at least one of one or more products or one or more services;
instructions for prompting the user for user information;
instructions for receiving a first set of user information from the user;
instructions for determining whether the user is an authenticated user based on analysis of the first set of user information from the user;
instructions for determining whether the user is qualified for purchase financing based on user membership relationship and financial management with a financial institution;
instructions for, based on a determination that the user is qualified for purchase financing based on user membership relationship with a financial institution, sending a notification to a lending agent authorizing financing of the at least one of one or more products or one or more services;
instructions for, based on the determination that the user is qualified for purchase financing based on user membership relationship with a financial institution, sending a purchase order for the at least one of one or more products or one or more services to a fulfillment agent for shipping the at least one of one or more products or one or more services to the user.

2. The apparatus of claim 1, wherein the determination that the user is qualified for purchase financing based on user membership relationship with a financial institution comprises receiving, from the user, a password that is generated and sent to the user in response to a periodic determination by the financial institution that the user is qualified for purchase financing.

3. The apparatus of claim 2, wherein the periodic determination comprises generating a weekly list of eligible members based on daily purchases reports of each member.

4. The apparatus of claim 1, wherein the financial institution is a credit union, and the user is a member of the credit union.

5. The apparatus of claim 1, wherein the user membership relationship with a financial institution comprises at least one of membership history that the user has with the financial institution or financial interaction history that the user has with the financial institution.

6. An apparatus, comprising:
one or more processors; and
a non-transitory computer readable medium in communication with the one or more processors, the computer readable medium having stored thereon software comprising a set of instructions that, when executed by the one or more processors, causes the apparatus to perform one or more operations, the set of instructions comprising:
instructions for receiving a first set of inputs from a user, the first set of inputs comprising a request to purchase at least one of one or more products or one or more services;
instructions for, based on a determination that the user is qualified for purchase financing based on user membership relationship with a financial institution, sending a notification to a lending agent authorizing financing of the at least one of one or more products or one or more services;
instructions for, based on the determination that the user is qualified for purchase financing based on user membership relationship with a financial institution, sending a purchase order for the at least one of one or more products or one or more services to a fulfillment agent for shipping the at least one of one or more products or one or more services to the user.

7. A method, comprising:
receiving, with a first computer, a first set of inputs from a user, the first set of inputs comprising a request to purchase at least one of one or more products or one or more services;
determining, with the first computer, eligibility of the user to receive financing for the at least one of one or more products or one or more services, based on membership history of the user with a financial institution.

8. The method of claim 7, further comprising:
based on a determination that the user is qualified to receive financing for the at least one of one or more products or one or more services based on membership history of the user with a financial institution, sending a notification to a lending agent authorizing financing of the at least one of one or more products or one or more services; and
based on a determination that the user is qualified to receive financing for the at least one of one or more products or one or more services based on membership history of the user with a financial institution, sending a purchase order for the at least one of one or more products or one or more services to a fulfillment agent for shipping the at least one of one or more products or one or more services to the user.

9. The method of claim 7, wherein the financial institution is a credit union, and the user is a member of the credit union.

10. The method of claim 7, wherein the user membership relationship with a financial institution comprises at least one of membership history that the user has with the financial institution or financial interaction history that the user has with the financial institution.
